(19) United States
(12) Patent Application Publication
(10) Pub. No.: US 2006/0130572 A1
(43) Pub. Date: Jun. 22, 2006

(54) Tank mass measurement assembly

(76) Inventor: Charles L. Northrop, Marysville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/016,390

(22) Filed: Dec. 16, 2004

(51) Int. Cl. G01F 3/02

(52) U.S. Cl. 73/149; 73/232

(57) ABSTRACT

A tank mass measuring assembly (10) for monitoring an amount of a fluid (20) stored in a tank (12). The monitoring assembly includes a mass measurement chamber (42) adapted to be located remotely of a tank and adapted to be coupled in fluid communication with the tank to receive a portion of a fluid stored in the tank. The monitoring assembly further includes a sensor assembly (16) at least partially disposed in the mass measurement chamber, the sensor assembly adapted to measure a mass of the fluid disposed in the mass measurement chamber. The sensor assembly is adapted to relay the measured mass to a computation device (90) for determining the amount of the fluid in the tank based upon the measured mass of the fluid disposed in the mass measurement chamber.

### FIELD OF THE INVENTION

The present invention relates generally to tank mass measurement assemblies, and more specifically, to tank mass measurement assemblies having a mass measurement chamber located externally of the tank.

### BACKGROUND OF THE INVENTION

Storage tanks for hydrocarbon products, a few suitable examples being LPG products such as butane and propane, present special problems for the installation of tank mass measuring assemblies. LPG storage tanks are classified as explosion hazards by the National Fire Protection Association (hereinafter “NFPA”), requiring special care in the design and installation of any ancillary equipment. The LPG Code (NFPA 58) defines the area within five feet of any tank, fill opening, or point where liquefied petroleum gas is dispensed, loaded, vented, or the like, as a Class I, Division 1, Group D hazard. Thus, special safeguards are in place, severely restricting the modification of a tank storing LPG products. The regulations surrounding the modification of a tank storing LPG products drastically increases the difficulty of installing a tank mass measuring assembly to the tank. This is especially true when components of the tank mass measuring assembly must be installed within the tank.

For instance, in previously developed tank LPG gauges, such as the one illustrated and described in U.S. Pat. No. 6,662,643, the disclosure of which is hereby expressly incorporated by reference, require the pressure vessel portion of the tank to be penetrated during installation. More specifically, portions of the mass measuring sensor assembly must be installed within the tank. Installing the mass measuring sensor assembly within the tank requires the tank to be opened. Since the fluid is volatile and contained within the tank at a pressure above atmospheric pressure, the tank must be purged prior to opening of the tank.

Further still, most tanks do not have an appropriate opening or openings able to accommodate the mounting and installation of the mass measuring sensor assembly within the tank. Thus, to accommodate the mounting of the mass measuring sensor assembly, an opening must be field welded upon the tank. The welding of the opening is an expensive operation, requiring a certified welder and the shutting down and purging of the tank for the work.

Even if an opening is present on the tank able to accommodate the insertion of the mass measuring sensor assembly within the tank, the tank be must shut down and be purged during the installation procedure, adding great expense to the installation operation. Further, even if a suitable opening is present on the tank, the opening is virtually never located in the optimum location, i.e., equidistant from the ends of the tank to negate inaccuracies caused by the effects of “slope” when the tank is not oriented perfectly horizontal.

Additionally, due to the complexity of inserting the mass measuring sensor assembly in the tank and the liability associated with modifying the tank, the installation of the tank mass measuring assembly requires highly trained individuals for proper installation further increasing the cost of installation.

Further still, previously developed load cell type mass measuring sensor assemblies use a mass probe which is suspended in the tank. However, the mass probe may suffer in accuracy since the mass probe cannot extend in length the full height of the tank since a clearance space must be present at the bottom end of the mass probe to prevent interference between the bottom end of the mass probe and the tank bottom or debris accumulating thereon. Thus, the accuracy of the mass measuring sensor assembly suffers, especially when the fluid level in the tank is at a very low level.

Therefore, there exists a need for a mass measuring sensor assembly and method of installation which permits the mass measuring sensor assembly to be installed without requiring the tank to be shutdown and purged, that may be installed without opening the tank to the atmosphere, that does not require the mass measuring sensor assembly to be installed equidistant between the ends of the tank for accurate results, and/or that can allow a mass probe having a length equal or greater than the height of the tank for improved accuracy.

### SUMMARY OF THE INVENTION

One embodiment of a tank mass measuring assembly formed in accordance with the present invention for monitoring an amount of a fluid stored in a tank is disclosed. The tank mass measuring assembly includes a mass measurement chamber adapted to be located remotely of a tank and adapted to be coupled in fluid communication with the tank to receive a portion of a fluid stored in the tank. The tank mass measuring assembly also includes a sensor assembly at least partially disposed in the mass measurement chamber. The sensor assembly is adapted to measure a mass of the fluid disposed in the mass measurement chamber. The sensor assembly is also adapted to relay the measured mass to a computation device for determining the amount of the fluid in the tank based upon the measured mass of the fluid disposed in the mass measurement chamber.

An alternate embodiment of a tank mass measuring assembly formed in accordance with the present invention for monitoring an amount of a fluid stored in a tank is disclosed. The tank mass measuring assembly includes a tank having a fluid stored in the tank. The tank mass measuring assembly further includes an outlet passageway for permitting the fluid to exit the tank for use by a device requiring the fluid and an inlet passageway. The inlet passageway permits the fluid to be returned to the tank. The tank mass measuring assembly also includes a mass measurement chamber located externally of the tank and coupled in fluid communication with both the outlet and inlet passageways of the tank. The tank mass measuring assembly further includes a sensor assembly at least partially disposed in the mass measurement chamber. The sensor assembly is adapted to measure a mass of the fluid disposed in the mass measurement chamber and to relay the measured mass to a computation device for determining the amount of the fluid in the tank.

One embodiment of a method performed in accordance with the present invention for installing a tank mass measuring assembly to a tank storing a pressurized fluid within the tank without purging the tank of the fluid is disclosed. The method includes closing an outlet valve on a fluid outlet line of the tank, closing an inlet valve on a fluid inlet line of the tank, and mounting a mass measurement chamber remotely of the tank. The method also includes coupling the mass measurement chamber in fluid communication with the fluid outlet downstream of the outlet valve and with the fluid inlet line upstream of the inlet valve. The method further includes installing a mass measuring sensor assembly at least partially within the mass measurement chamber for measuring a mass of the fluid in the mass measuring chamber and opening the inlet and outlet valves to permit fluid from the tank to freely enter and exit the mass measurement chamber.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an elevation view of one embodiment of a tank containing a fluid having a tank mass measuring assembly installed in accordance with the present invention;

FIG. 2 is a cross-sectional view of the tank and tank mass measuring assembly of FIG. 1 taken substantially through Section 2-2 of FIG. 1;

FIG. 3 is a partially exploded perspective view of an upper portion of a sensor assembly shown in FIG. 1; and

FIG. 4 is an elevation view of a mass probe shown in FIG. 3.

### DETAILED DESCRIPTION OF THE PREFERRED EMBODIMENT

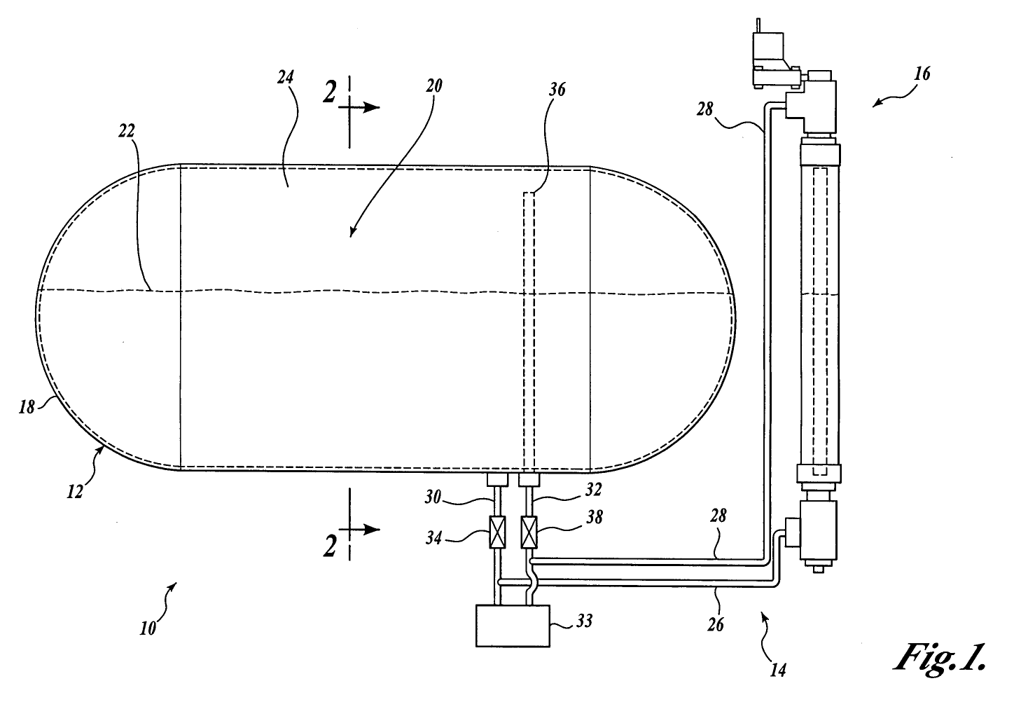

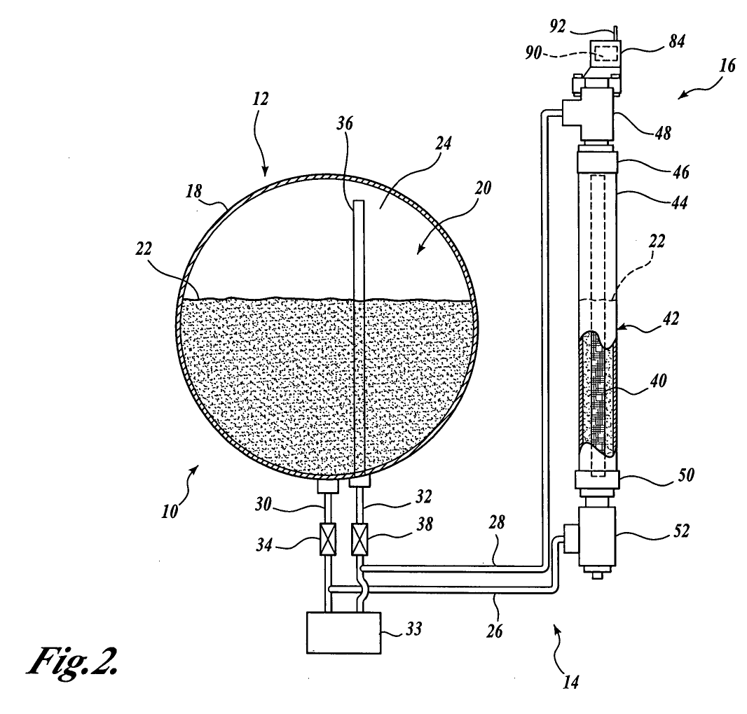

Turning to FIGS. 1 and 2, one embodiment of a tank mass measuring assembly 10 formed in accordance with the present invention is shown. The tank mass measuring assembly 10 includes a tank 12 for storing a fluid 20, a piping assembly 14, and a sensor assembly 16. The tank 12 of the illustrated embodiment includes a pressure vessel 18 able to store the fluid 20 at an elevated pressure, i.e., a pressure above atmospheric pressure. The tank 12 is preferably adapted for storing a liquefied hydrocarbon product, a few suitable examples being butane and propane, wherein the fluid 20 is stored within the tank 12 as a mixture of a liquid 22 and a vapor or gas 24.

The piping assembly 14 includes a liquid line 26 and a gas line 28. The liquid line 26 couples the sensor assembly 16 in fluid communication with the tank 12 for permitting the transfer of the liquid 22 between the tank 12 and the remotely located sensor assembly 16. Likewise, the gas line 28 couples the sensor assembly 16 in fluid communication the tank 12 for permitting the transfer of the gas 24 between the tank 12 and the remotely located sensor assembly 16.

The liquid line 26 and gas line 28 are coupled to a liquid outlet line 30 and a gas return line 32. The liquid outlet line 30 is a section of pipe which penetrates the pressure vessel 18 of the tank 12, terminating at a bottom of the tank 12. The liquid outlet line 30 collects the liquid 22 in the tank and provides a passageway for the liquid 22 to be drawn out of the tank 12 as needed and used or manipulated by a device 33 requiring the liquid 22, such as a transfer pump or other piece of machinery wherein the fluid 20 is combusted or used in some other process. The liquid line 30 also permits the fluid 20 to freely flow to and from the tank 12 to equalize the weights of the mass column in the remotely located sensor assembly 16. An outlet valve 34 is disposed in the liquid outlet line 30. The outlet valve 34 is adapted to be closed to impede flow of the liquid 22 through the outlet valve 34 and isolate the tank 12 or opened to permit a flow of the liquid through the outlet valve 34. The liquid line 26 is coupled to the liquid outlet line 30 downstream of the outlet valve 34 such that the outlet valve 34 can be closed to isolate the tank 12 from the liquid line 26 during installation, removal, safety protection, or maintenance of the tank mass measuring assembly 10.

The gas return line 32 is a section of pipe which penetrates the pressure vessel 18 of the tank 12, passing through a riser 36 vertically disposed within the tank 12. In an alternative embodiment, the gas return line 32 may enter the tank 12 through topside piping when openings and valving are available. The riser 36 terminates near a top of the tank 12, above a maximum liquid 22 level in the tank 12. The gas return line 32 provides a passageway for unused fluid 20, typically in a gaseous state, to be returned to the tank 12 as needed. An inlet valve 38 is disposed in the gas return line 32. The inlet valve 38 is adapted to be closed to impede flow of the gas 24 past the inlet valve 38, thereby isolating the tank 12. The gas line 28 is coupled to the gas return line 32 upstream of the inlet valve 38 such that the inlet valve 38 can be closed to isolate the tank 12 from the gas line 28 during installation or maintenance of the tank mass measuring assembly 10.

Turning to FIG. 2, this detailed description will now focus upon the sensor assembly 16. The sensor assembly 16 is a device for measuring a mass of a fluid 20 disposed in a mass measurement chamber 42 so that an amount (i.e., a level, a weight, and/or a volume) of the fluid 20 stored in the tank 12 can be determined. The sensor assembly 16 may measure the mass of the fluid disposed in the mass measurement chamber 42 in any number of ways, a few suitable examples being through ultrasonic, magnetostrictive, SONAR, and RADAR technologies. The sensor assembly 16 of the illustrated embodiment utilizes a float system for determining the mass of the fluid within the mass measurement chamber 42, however it should be apparent to those skilled in the art that other methods for determining the mass of the fluid are within the spirit and scope of the present invention, including, but not limited to, those methods mentioned above.

The mass measurement chamber 42 includes a riser pipe 44 having a top end and a bottom end. Coupled to the bottom end of the riser pipe 44 is a bottom cap 50. Coupled to the bottom cap 50 is a piping connection 52 permitting the liquid line 26 to be coupled in fluid communication with the mass measurement chamber 42. Coupled to the top end of the riser pipe 44 is a top cap 46. Coupled to the top cap 46 is a piping connection 48 permitting the gas line 28 to be coupled in fluid communication with the mass measurement chamber 42. Coupled to the top of the piping connection 48 is a control assembly 84 for calculating a mass or a volume of the contents of the tank 12 as will be described in more detail below. A conventional pressure-proof (and fire proof) electrical cable pass-through (not shown) passes axially through the piping connection 48 thereby permitting electrical signals to pass between the electronics located in the pressurized mass measurement chamber 42 and the control assembly 84.

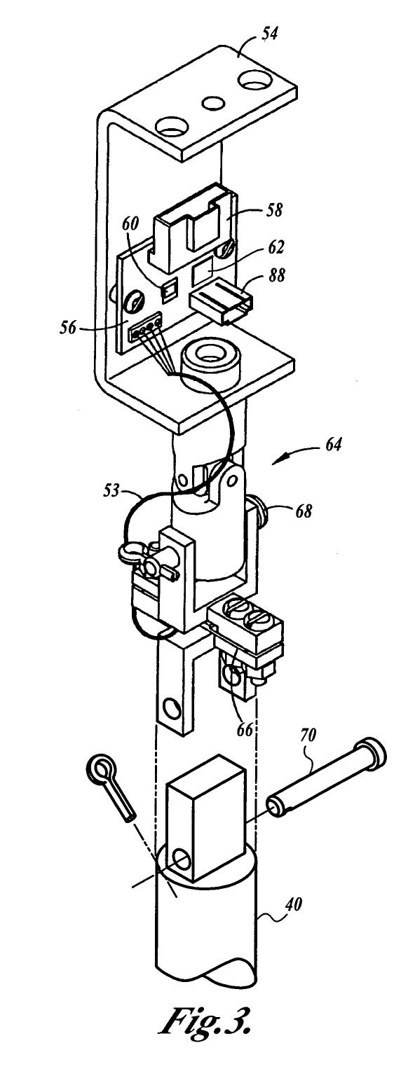

Turning to FIGS. 2 and 3, a hanger bracket 54 is provided for suspending the in-tank elements of the apparatus. The sensor assembly 16 also includes a well-known circuit board 56 mounted on the hanger bracket 54. The circuit board 56 is provided with a connector 58 for connecting the cable pass-through from the control assembly 84 in signal communication with the circuit board 56. The circuit board 56 includes a first temperature sensor 60 for measuring the air temperature in the upper portion of the mass measurement chamber 42 and a pressure sensor 62 for measuring a pressure in the mass measurement chamber 42. Although the first temperature sensor 60 and the pressure sensor 62 are illustrated and described as being present on the circuit board 56, it should be apparent to those skilled in the art that they may be located in alternate locations without departing from the spirit and scope of the present invention.

A universal joint assembly 64 is suspended below the hanger bracket 54. The universal joint assembly 64 may be any suitable commercially available universal joint assembly, one suitable example being Part No. 64565K1 from McMaster-Carr Supply Company. One end of the universal joint assembly 64 is secured to the hanger bracket 54. The other end of the universal joint assembly 64 is coupled to a sensor, which in the illustrated embodiment is a load cell 66, of the sensor assembly 16 by a pivot pin 68. Suspended from the load cell 66 by a clevis pin 70 is a mass probe 40. The universal joint assembly 64 permits the mass probe 40 to hang vertically within the mass measurement chamber 42 even if the mass measurement chamber 42 is out of vertical plumb.

The load cell 66 is able to measure the weight of the mass probe 40 when the mass probe 40 is suspended within a fluid contained in the mass measurement chamber 42. In other words, the downward force applied by the mass probe 40 upon the load cell 66 is converted into an electrical signal proportional to the downward force applied. The downward force applied to the load cell 66 is in turn proportional to a buoyant force applied to the mass probe 40 by the mass of the fluid 20 present in the mass measurement chamber 42. The electrical signal from the load cell 66 is sent to the circuit board 56 for processing.

An additional benefit of the universal joint assembly 64 is that the load cell 66 is oriented horizontally. This eliminates the need for measurement and correction for any variation of the load cell 66 from the horizontal. Were the load cell 66 permitted to be oriented out of horizontal, its measurements of force would be reduced by the sine of the angle of deviation. The universal joint assembly 64 eliminates this source of error, and the necessity of compensation.

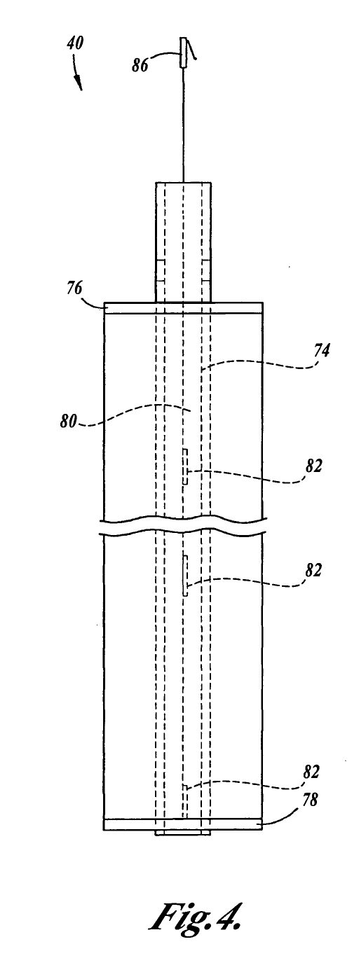

Turning to FIG. 4, the mass probe 40 may be a hollow tubular aluminum extrusion having lightening passages, such as a vertically extending central passage 74 to lighten the mass probe 40 and increase its buoyancy. End covers 76 and 78 are secured to each end of the mass probe 40 to close the ends of the mass probe 40 while leaving the central passage 74 open to the liquid contents of the mass measurement chamber 42.

The sensor assembly 16 further includes a flexible temperature probe string 80. The mass probe 40 houses the flexible temperature probe string 80 within the central passage 74 of the mass probe 40. A plurality of temperature sensors 82 are spaced along the temperature probe string 80 for measuring the temperature of the liquid contents at spaced levels. In the preferred embodiment, the temperature sensors 82 are spaced so that they are suspended at approximately 5%, 35% and 65% of tank height levels within the tank 12. Each temperature sensor 82 is coupled in signal communication with the circuit board. The temperature probe string 80 includes a connector 86 for coupling the temperature probe string 80 in signal communication with the circuit board via connector 88 on the circuit board 56 (see FIG. 3).

Referring to FIGS. 2 and 4, the data conveyed from the load cell 66, pressure sensor 62, temperature sensors 60 and 82, and circuit board 56 is communicated externally of the pressure containing portion of the mass measurement chamber 42 to a microprocessor 90 of the control assembly 84. The microprocessor 90 calculates the volume of contents in the tank from: (1) the apparent weight of the mass probe 40 as determined by the load cell 66, compensated for air temperature surrounding the load cell 66 as measured by temperature sensor 60; (2) the liquid temperature data from temperature sensors 82; and (3) the specific gravity curve for the stored liquid 22. The control assembly 84 also houses a radio frequency transmitter/receiver 92 which can transmit the data to a master computer. This eliminates the need for a power hook-up within the hazardous area of the tank, as the microprocessor and radio may be conveniently operated on safe battery power. Although the above illustrated and described embodiment is described as having the microprocessor 90 and control assembly 84 as coupled directly to the mass measurement chamber 42, it should be apparent to those skilled in the art that microprocessor 90 and/or the control assembly may be located remotely of the mass measurement chamber 42 without departing from the spirit and scope of the present invention.

Although the above described and illustrated embodiment measures the suspended weight of the mass probe, it should be apparent to those skilled in the art that the sensor assembly may determine the weight of the mass probe in any number of ways without departing from the spirit and scope of the present invention, a few suitable examples being by supporting the mass probe by a well known load cell or pressure sensor placed underneath the mass probe to determine the weight of the mass probe or measuring the amount in which the mass probe displaces a biasing member, such as a spring, that either supports or suspends the mass probe within the fluid contained in the mass measurement chamber.

Further still, although the sensor assembly is illustrated and described as utilizing a single mass probe, it should be apparent to those skilled in the art that the sensor assembly may utilize two or more mass probes for determining the mass of the fluid disposed in the mass measurement chamber. One suitable example of a multiple probe configuration suitable for use with and that is within the spirit and scope of the present invention is disclosed in U.S. Pat. No. 5,157,968, the disclosure of which is hereby expressly incorporated by reference.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A tank mass measuring assembly for monitoring an amount of a fluid stored in a tank comprising:
(a) a mass measurement chamber adapted to be located remotely of a tank and adapted to be coupled in fluid communication with the tank to receive a portion of a fluid stored in the tank; and
(b) a sensor assembly at least partially disposed in the mass measurement chamber, the sensor assembly adapted to measure a mass of the fluid disposed in the mass measurement chamber and relay the measured mass to a computation device for determining the amount of the fluid in the tank based upon the measured mass of the fluid disposed in the mass measurement chamber.

2. The tank mass measuring assembly of claim 1, wherein the mass measurement chamber is of a predetermined height, the predetermined height about equal to or greater than a height of the tank.

3. The tank mass measuring assembly of claim 1, wherein the mass measurement chamber is oriented substantially vertically.

4. The tank mass measuring assembly of claim 1, wherein the sensor assembly includes a sensor coupled to a mass probe, wherein the sensor is adapted to measure a weight of the mass probe in the mass measurement chamber.

5. The tank mass measuring assembly of claim 4, wherein the mass probe is of a predetermined height, the predetermined height about equal to or greater than a height of the tank.

6. The tank mass measuring assembly of claim 1, further comprising a piping assembly for coupling the mass measurement chamber in fluid communication with the tank, the piping assembly including a liquid line for transporting a liquid from the tank to the mass measurement chamber and a gas line for transporting a gas between the tank and the mass measurement chamber.

7. The tank mass measuring assembly of claim 6, wherein the liquid line passes through a bottom wall of the tank and the gas line pass through a top wall or a bottom wall of the tank.

8. The tank mass measuring assembly of claim 1, wherein the sensor assembly further includes at least one temperature sensor for measuring a temperature of the fluid in the mass measurement chamber.

9. The tank mass measuring assembly of claim 1, wherein the sensor assembly further includes at least one temperature sensor for measuring a temperature of a liquid in the mass measurement chamber and at least one temperature sensor for measuring a temperature of a gas in the mass measurement chamber.

10. The tank mass measuring assembly of claim 1, wherein the sensor assembly further includes a pressure sensor for sensing a pressure of the fluid in the mass measurement chamber.

11. The tank mass measuring assembly of claim 1, wherein the mass measurement chamber is a pressure vessel able to withstand pressures elevated a predetermined amount above an atmospheric pressure.

12. A tank mass measuring assembly for monitoring an amount of a fluid stored in a tank comprising:
(a) a tank having a fluid stored in the tank;
(b) an outlet passageway for permitting the fluid to exit the tank for use by a device requiring the fluid;
(c) an inlet passageway for permitting the fluid to be returned to the tank;
(d) a mass measurement chamber located externally of the tank and coupled in fluid communication with both the outlet and inlet passageways of the tank; and
(e) a sensor assembly at least partially disposed in the mass measurement chamber, the sensor assembly adapted to measure a mass of the fluid disposed in the mass measurement chamber and relay the measured mass to a computation device for determining the amount of the fluid in the tank.

13. The tank mass measuring assembly of claim 12, wherein the outlet and inlet passageway each include a valve which normally remains open during use of the mass measurement chamber and which are closed when the mass measurement chamber is not used, and wherein the mass measurement chamber is attached to the outlet passageway downstream of the valve and to the inlet passageway upstream of the valve.

14. The tank mass measuring assembly of claim 12, wherein the mass measurement chamber is of a predetermined height, the predetermined height about equal to or greater than a height of the tank.

15. The tank mass measuring assembly of claim 12, wherein the mass measurement chamber extends from about at or below a minimum liquid level of the fluid in the tank to about at or above a maximum liquid level of the fluid in the tank.

16. The tank mass measuring assembly of claim 12, wherein the sensor assembly includes a sensor coupled to a mass probe, wherein the sensor is adapted to measure a weight of the mass probe in the mass measurement chamber.

17. The tank mass measuring assembly of claim 16, wherein the mass probe is of a predetermined height, the predetermined height about equal to or greater than a height of a maximum liquid level in the tank.

18. The tank mass measuring assembly of claim 12, wherein the sensor assembly further includes one or more temperature sensors for measuring a temperature of the fluid in the mass measurement chamber.

19. The tank mass measuring assembly of claim 12, wherein the sensor assembly further includes one or more temperature sensors for measuring a temperature of a liquid in the mass measurement chamber and one or more temperature sensors for measuring a temperature of a gas in the mass measurement chamber.

20. The tank mass measuring assembly of claim 12, wherein the mass measurement chamber is a pressure vessel able to withstand pressures greater than atmospheric pressures.

21. A method of installing a tank mass measuring assembly to a tank storing a pressurized fluid within the tank without purging the tank of the fluid, the method comprising:
(a) closing an outlet valve on a fluid outlet line of the tank;
(b) closing an inlet valve on a fluid inlet line of the tank;
(c) mounting a mass measurement chamber remotely of the tank;
(d) coupling the mass measurement chamber in fluid communication with the fluid outlet downstream of the outlet valve and with the fluid inlet line upstream of the inlet valve;
(e) installing a mass measuring sensor assembly at least partially within the mass measurement chamber for measuring a mass of the fluid in the mass measurement chamber; and
(f) opening the inlet and outlet valves to permit fluid from the tank to freely enter and exit the mass measurement chamber.

22. The method of claim 21, further including installing at least one temperature sensor in the mass measurement chamber to sense a temperature of the fluid in the mass measurement chamber.

23. The method of claim 21, further including installing two or more temperature sensors in the mass measurement chamber, wherein at least one of the temperature sensors is adapted to sense a temperature of a gas component of the fluid in the mass measurement chamber, and wherein at least one of the temperature sensors is adapted to sense a temperature of a liquid component of the fluid in the mass measurement chamber.

24. The method of claim 21, further comprising isolating the tank during the installation of the tank monitoring assembly such that the fluid within the tank is maintained at a pressure above atmospheric pressure during installation of the tank monitoring assembly.
